(19) United States
(12) Patent Application Publication
(10) Pub. No.: US 2008/0241695 A1
(43) Pub. Date: Oct. 2, 2008

(54) CARBON NANOTUBE COMPOSITE ELECTRODE MATERIAL, METHOD FOR MANUFACTURING THE SAME AND ELECTRODE ADOPTING THE SAME

(75) Inventors: PENG-CHENG SONG, Beijing (CN); DING WANG, Beijing (CN); CHANG-HONG LIU, Beijing (CN); SHOU-SHAN FAN, Beijing (CN)

Correspondence Address: PCE INDUSTRY, INC.;ATT. CHENG-JU CHIANG, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng (TW)

(21) Appl. No.: 11/951,167

(22) Filed: Dec. 5, 2007

(30) Foreign Application Priority Data
Mar. 23, 2007 (CN) 200710073646.2

(51) Int. Cl. H01M 4/58; H01B 1/04

(52) U.S. Cl. 429/231.8; 252/502

(57) ABSTRACT

The present invention relates to a carbon nanotube composite electrode material, a method for manufacturing the same and an electrode including the carbon nanotube composite material. The carbon nanotube electrode material includes carbon fibers and carbon nanotubes. The carbon fibers constitute a network structure. The carbon nanotubes are wrapped around and adhering to the carbon fibers. Because a diameter of the carbon fibers is about 100 times larger than that of the carbon nanotubes, gaps between the carbon fibers are also larger than that between the carbon nanotubes such that electrolytes can easily penetrate into the carbon fibers and come into contact with all or nearly all of the available surface area of the carbon nanotubes. In other words, an effective surface area of the carbon nanotubes is improved, and capacity of electrode material is also improved.

### BACKGROUND

1. Field of the Invention

The invention generally relates to composite electrode materials, methods for manufacturing the same and electrodes adopting the same and, particularly, to a carbon nanotube composite electrode material, a method for manufacturing the same, and an electrode adopting the same.

2. Discussion of Related Art

Batteries of portable electronic products include lithium ion type batteries and lithium ion polymer type batteries. In the lithium ion type battery, a negative electrode is, opportunely, made of carbon materials such as graphite. However, carbon nanotubes have a large specific surface area and are increasingly being used to replace the graphite to act as the negative electrode in the lithium ion type battery. Due to the gaps between the carbon nanotubes being small, it is difficult for ions electrolytes and/or reactive materials to pass through the gaps, and thus this increase in surface area is not fully utilized. That is, when carbon nanotubes are used to make the negative electrode in a lithium ion type battery, the advantage of large specific surface area of carbon nanotubes is not exploited.

What is needed, therefore, is a carbon nanotube composite electrode material having a usable large effective specific area, a method for manufacturing the same and an electrode including the same therein.

### SUMMARY

A carbon nanotube composite electrode material includes carbon fibers and carbon nanotubes. The carbon fibers constitute a network structure. The carbon nanotubes are wrapped about and adhered to the carbon fibers.

Other advantages and novel features of the present carbon nanotube composite electrode material, a related method for manufacturing the same, and a related electrode adopting the same will become more apparent from the following detailed description of present embodiments when taken in conjunction with the accompanying drawings.

### BRIEF DESCRIPTION OF THE DRAWINGS

Many aspects of the present carbon nanotube composite electrode material, the related method for manufacturing the same, and the related electrode adopting the same can be better understood with reference to the following drawings. The components in the drawings are not necessarily to scale, the emphasis instead being placed upon clearly illustrating the principles of the present carbon nanotube composite electrode material, the related method for manufacturing the same, and the related electrode adopting the same.

FIG. 1 is a schematic view of a carbon nanotube composite electrode material, in accordance with the present embodiment.

FIG. 2 is a flow chart of a method for manufacturing the carbon nanotube composite electrode material shown in FIG. 1.

FIG. 3 is a schematic view of an electrode including the carbon nanotube composite material shown in FIG. 1.

Corresponding reference characters indicate corresponding parts throughout the several views. The exemplifications set out herein illustrate at least one present embodiment of the carbon nanotube composite electrode material, the related method for manufacturing the same, and the related electrode adopting the same, in at least one form, and such exemplifications are not to be construed as limiting the scope of the invention in any manner.

### DETAILED DESCRIPTION OF PREFERRED EMBODIMENTS

Reference will now be made to the drawings, in detail, to describe embodiments of the carbon nanotube composite electrode material, the method for manufacturing the same, and the electrode adopting the same.

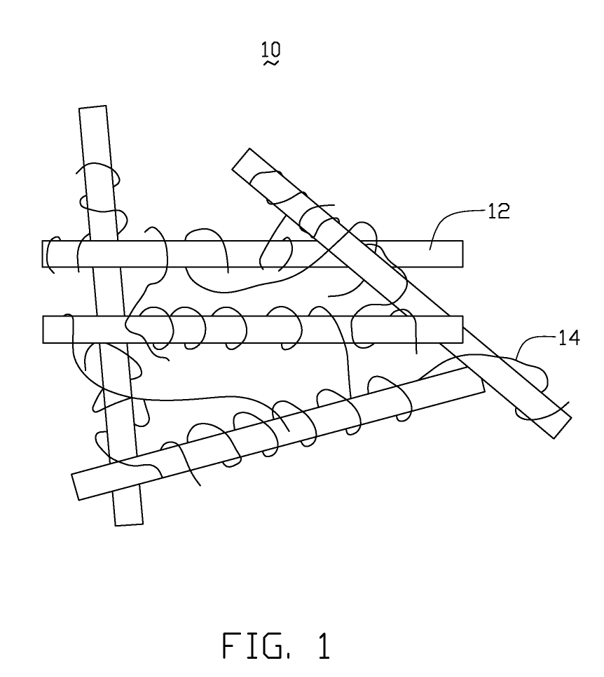

Referring to FIG. 1, a carbon nanotube composite electrode material 10 includes carbon fibers 12 and carbon nanotubes 14. The carbon fibers 12 constitute a network structure. The carbon nanotubes 14 are wrapped around and adhering to the carbon fibers 12.

The carbon nanotube composite electrode material 10, opportunely, is a film or sheet. A thickness of the film or sheet is in the approximate range from 100 μm (micrometer) to 10 mm (millimeter). A diameter of the carbon fibers 12 is in the approximate range from 2 μm to 50 μm. A length of the carbon fibers 12 is in the approximate range from 500 μm to 5 mm. The carbon nanotubes 14 are single-walled carbon nanotubes or multi-walled carbon nanotubes. A diameter of the carbon nanotubes 14 is in the approximate range from 20 nm (nanometer) to 100 nm. A length of the carbon nanotubes 14 is above 110 μm. Because the diameter of the carbon fibers 12 is about 100 times larger than that of the carbon nanotubes 14, gaps between the carbon fibers 12 are also larger than that between the carbon nanotubes 14, such that the electrolyte and/or reactive materials can easily penetrate into the carbon fibers 12 and come into contact with all or nearly all of the available surface area of the carbon nanotubes 14. In other words, an effective specific surface area of the carbon nanotubes 14 is improved, and the capacity of the electrode material is also improved. As such, the capacity of batteries made using the present carbon nanotube composite electrode material 10 is also improved.

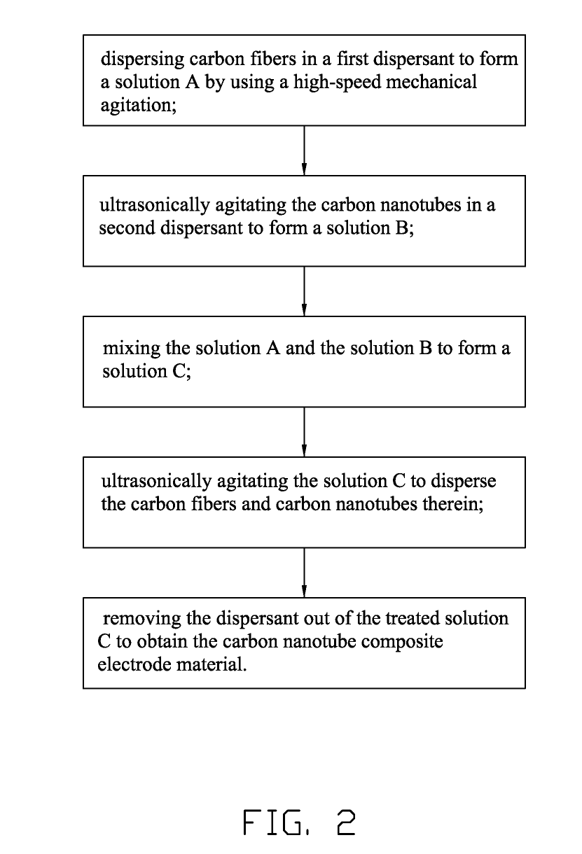

Referring to FIG. 2, a method for manufacturing the present carbon nanotube composite electrode material 10 includes the following steps: (a) dispersing the carbon fibers in a first dispersant to form a solution A, by using high-speed mechanical agitation; (b) ultrasonically agitating carbon nanotubes in a second dispersant to form a solution B; (c) mixing the solution A and the solution B to form a solution C; (d) ultrasonically agitating the solution C to disperse the carbon fibers and the carbon nanotubes therein; (e) removing the dispersant out of the treated solution C to obtain the carbon nanotube composite electrode material.

In step (a), a diameter of the carbon fibers is in the approximate range from 2 μm˜100 μm. A length of the carbon fibers is in the approximate range from 0.5 mm˜5 mm. A required size of the carbon fibers can be obtained by cutting. The first dispersant comprises a substance selected from a group consisting of water, ethanol, acetone, dimethylformamide, and any combination thereof. The first dispersant is used to disperse the carbon fibers 12. An amount of the first dispersant can be chosen according to practical needs in the present embodiment, and only needs to maintain uniform dispersion of the carbon fibers 12 therein. A method to disperse the carbon fibers 12 in the first dispersant is high-speed mechanical agitation method. A time of the mechanical agitation is in the approximate range from 5-10 minutes to break up connections between the carbon fibers 12. After mechanical agitation, the carbon fibers 12 are dispersed in the solution A, and partial carbon fibers connect to one another.

In step (b), the second dispersant is used to disperse the carbon nanotubes 14. The second dispersant comprises a substance selected from a group consisting of water, ethanol, acetone, dimethylformamide, and any combination thereof. The composition of the second dispersant can be the same as, or different from the first dispersant. An amount of the second dispersant can be chosen according to the practical needs of the present embodiment, and should only maintain uniform dispersion of the carbon nanotubes 14 therein. A method to disperse the carbon nanotubes in the second dispersant is an ultrasonic agitation method. A power of the ultrasonic vibrator is in the approximate range from 800 W (Watt) to 1200 W. In the present embodiment, when the power of the ultrasonic vibrator is about 1000 W, the time of ultrasonic agitation is in the approximate range from 10-60 minutes to form a flocculent solution B. It is to be understood that the time of ultrasonic agitation treatment decreases, as the power of the ultrasonic vibrator increases.

In step (c), the solution A and the solution B are mixed to form a uniformly dispersed solution C. Quite usefully, a weight ratio of the carbon fibers 12 to the carbon nanotubes 14 is chosen in the approximate range from 1:1 to 10:1 by controlling the mixing ratio of the solution A to the solution B. The diameter of the carbon fibers 12 is about 100 times bigger than that of the carbon nanotubes 14.

In step (d), after a period of time of forming the solution C, most of the carbon nanotubes 14 are wrapped about and adhered to the carbon fibers 14 therein; thereby the structure shown in FIG. 1 is formed. It is to be understood that depending on the power of ultrasonic vibrator used in the present embodiment, the time of ultrasonic agitation is variable. As such, the higher the power of the ultrasonic vibrator used in the present embodiment, the shorter the time used to ultrasonically agitate the solution B and C. In one useful embodiment, the power of the ultrasonic vibrator is about 1000 W, and the time of ultrasonic agitation is in the approximate range from 10-30 minutes.

In step (e), a process of removing the dispersant (the first and second dispersants combined) from the solution C can be a drying process and a drawing-infiltrating process. In the present embodiment, the solution C is put into a container to form a liquid layer, and the liquid layer has a certain thickness. After drying, the carbon nanotube composite electrode material is obtained. Quite usefully, the thickness of the carbon nanotube composite electrode material is in the approximate range from 0.1 mm to 10 mm.

It is noted that the step (a) and the step (b) can occur in reverse order at the same time.

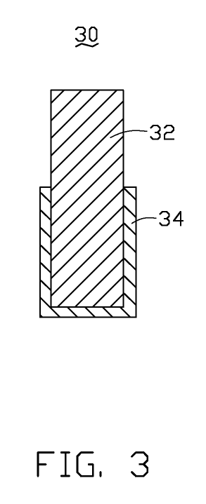

Referring to FIG. 3, the present embodiment also provides an electrode 30 including the carbon nanotube composite electrode material. The electrode 30 includes a substrate 32 and the carbon nanotube composite electrode material 34 disposed on the substrate 32. The carbon nanotube composite electrode material 34 is coated on one end of the substrate 32, or the entire substrate 32. In the present embodiment, the carbon nanotube composite electrode material 34 is coated on the one end of the substrate 32. The substrate 32 could be selected, e.g., from a group consisting of metal materials such as copper, aluminum, nickel, or from a group consisting of conductive non-metal materials such as graphite.

The electrode 30 can be obtained by attaching the carbon nanotube composite electrode material 34 to the substrate 32 by a conductive tape. In addition, the electrode 30 can also be produced/obtained by the following steps. Firstly, the solution C is spray-coated or otherwise applied on the substrate 32. Secondly, the substrate 32 with the solution C thereon is dried to form the electrode 30 including the carbon nanotube composite electrode material 34. To achieve a predetermined thickness of the electrode material, the coating step can be repeatedly several times.

It is noted that the electrode 30 can include the substrate 32 in the present embodiment. However, the substrate 32 is not necessary to the electrode 30. That is, the electrode 30 can, opportunely, be made of the carbon nanotube composite electrode material 34 without the substrate 32 and have a predetermined shape.

Compared with the conventional electrode used in a capacitor or battery, because the diameter of the carbon fibers 12 is about 100 times bigger than that of the carbon nanotubes 14, gaps between the carbon fibers 12 are also bigger than that between the carbon nanotubes 14, such that electrolyte can easily penetrate into the carbon fibers 12 contacting a greater amount of the surface area of the carbon nanotubes 14. In other words, an effective specific surface area of the carbon nanotubes 14 is improved, and capacity of the battery made by the carbon nanotube composite electrode material 10 is also improved.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A carbon nanotube composite electrode material comprising:
a plurality of carbon fibers constituting a network structure; and
a plurality of carbon nanotubes are wrapped around and adhering to the carbon fibers.

2. The carbon nanotube composite electrode material as claimed in claim 1, wherein a diameter of the carbon fibers is in the approximate range from 2 micrometers to 50 micrometers.

3. The carbon nanotube composite electrode material as claimed in claim 1, wherein a length of the carbon fibers is in the approximate range from 500 micrometers to 5 millimeters.

4. The carbon nanotube composite electrode material as claimed in claim 1, wherein a length of the carbon nanotubes is above 10 micrometers.

5. The carbon nanotube composite electrode material as claimed in claim 1, wherein a diameter of the carbon nanotubes is in the approximate range from 20 nanometers to 100 nanometers.

6. The carbon nanotube composite electrode material as claimed in claim 1, wherein a thickness of the carbon nanotube composite electrode material is in the approximate range from 100 micrometers to 10 millimeters.

7. The carbon nanotube composite electrode material as claimed in claim 1, wherein a weight ratio of the carbon fibers to the carbon nanotubes therein is in the approximate range from 1:1 to 10:1.

8. An electrode comprising:
a substrate comprising a surface; and
a carbon nanotube composite electrode material disposed on the surface of the substrate, the carbon nanotube composite electrode material comprising carbon fibers and carbon nanotubes, the carbon fibers constituting a network structure and the carbon nanotubes are wrapped around and adhering to the carbon fibers.

9. The electrode as claimed in claim 8, wherein a diameter of the carbon fibers is in the approximate range from 2 micrometers to 50 micrometers, and a length of the carbon fibers is in the approximate range from 500 micrometers to 5 millimeters.

10. The electrode as claimed in claim 8, wherein a length of the carbon nanotubes is above 10 micrometers.

11. The electrode as claimed in claim 8, wherein a diameter of the carbon nanotubes is in the approximate range from 20 nanometers to 100 nanometers.

12. The electrode as claimed in claim 8, wherein a thickness of the carbon nanotube composite electrode material is in the approximate range from 100 micrometers to 10 millimeters.

13. The electrode as claimed in claim 8, wherein a weight ratio of the carbon fibers to the carbon nanotubes therein is in the approximate range from 1:1 to 10:1.

14. A method for making a carbon nanotube composite electrode material, the method comprising the steps of:
(a) dispersing a plurality of carbon fibers in a first dispersant to form a solution A by using high-speed mechanical agitation;
(b) ultrasonically agitating a plurality of the carbon nanotubes in a second dispersant to form a solution B;
(c) mixing the solution A and the solution B to form a solution C;
(d) ultrasonically agitating the solution C to disperse the carbon fibers and carbon nanotubes therein;
(e) removing the dispersant from the treated solution C to obtain the carbon nanotube composite electrode material.

15. The method as claimed in claim 14, wherein in step (a), the time for dispersing the carbon fibers in the solution A is in the approximate range from 5-10 minutes.

16. The method as claimed in claim 14, wherein the dispersant comprises a substance selected from a group consisting of water, ethanol, acetone, dimethylformamide, and any combination thereof.

17. The method as claimed in claim 14, wherein in step (b), the time for ultrasonic agitation to disperse the carbon nanotubes is in the approximate range from 10-60 minutes.

18. The method as claimed in claim 14, wherein in step (d), the time for ultrasonic agitation to disperse the carbon fibers and the carbon nanotubes in the solution C is in the approximate range from 10 to 30 minutes.

19. The method as claimed in claim 14, wherein in step (e), removing the dispersant from the solution C is executed by one of a drying process and a drawing-infiltrating process.

20. The method as claimed in claim 14, wherein the weight ratio of the carbon fibers to the carbon nanotubes in the solution C is in the approximate range from 1:1 to 10:1.
